(19) United States
(12) Patent Application Publication
(10) Pub. No.: US 2011/0075949 A1
(43) Pub. Date: Mar. 31, 2011

(54) IMAGE SEARCHING SYSTEM AND METHOD THEREOF

(75) Inventor: XIAN-WEI MA, Shenzhen City (CN)

(73) Assignees: HONG FU JIN PRECISION INDUSTRY (ShenZhen) CO. LTD., Shenzhen City (CN); HON HAI PRECISION INDUSTRY CO., LTD., Tu-cheng (TW)

(21) Appl. No.: 12/629,886

(22) Filed: Dec. 3, 2009

(30) Foreign Application Priority Data
Sep. 25, 2009 (CN) 200910307698.0

(51) Int. Cl. G06K 9/54; G06F 17/30

(52) U.S. Cl. 382/305; 707/706

(57) ABSTRACT

An image searching system comprises an input unit for receiving a user input; a storage unit for storing a database and a color code list. The database stores a plurality of image files. The color code list records a plurality of numeric codes corresponding to each color code. A read module acquires an image file. A searching condition selection module receives an area selection of the acquired image file as a search condition. A color scan module scans and analyzes the search condition to acquire a color code. A color-encoding module converts the color code of the search condition into a numeric code according to the color code list. An image search module searches the image file whose numeric code matches the numeric code of the search condition, and outputs a result. A searching control module displays the matched image file on the display unit according to the result.

### BACKGROUND

1. Technical Field

The present disclosure relates to an image searching system and a method thereof.

2. Description of Related Art

Conventionally, finding an image file involves entering a file name or a partial file name and then searching a part or all of the available storage devices or the web for a match of the file name. The conventional way works well when the file name or part of it is known. However, it is difficult to find images without knowing file names.

Therefore, what is needed is an image searching system which can searches image files.

### BRIEF DESCRIPTION OF THE DRAWINGS

FIG. 1 is a block diagram of the hardware infrastructure of an image searching system in accordance with an exemplary embodiment.

FIG. 2 is a schematic diagram indicating one area of an image being as a search condition in accordance with an exemplary embodiment.

FIG. 3 is a flowchart of an image searching method implemented by the image searching system of FIG. 1 in accordance with an exemplary embodiment.

### DETAILED DESCRIPTION

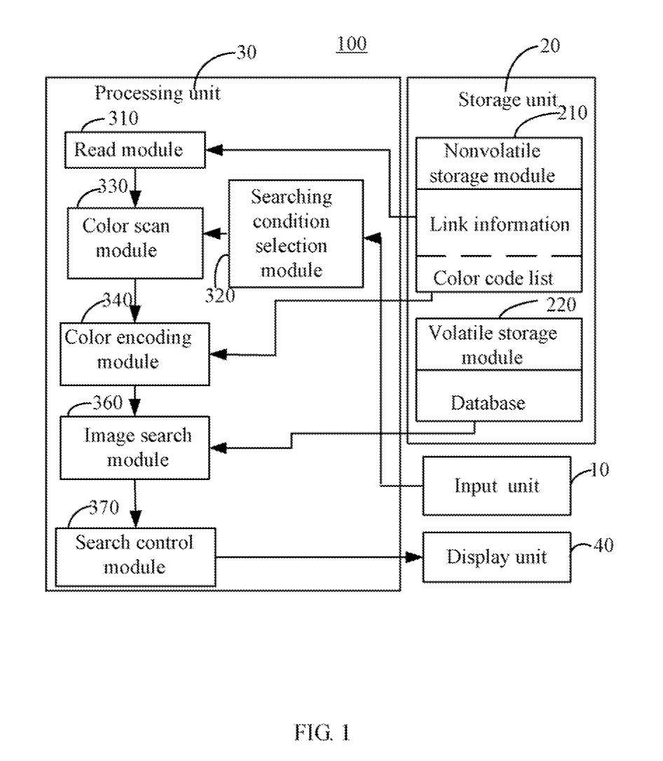

Referring to FIG. 1 that is a block diagram of the hardware infrastructure of the image searching system 100 in accordance with an exemplary embodiment. The image searching system 100 includes an input unit 10, a storage unit 20, a processing unit 30, and a display unit 40.

The input unit 10 is configured for receiving a user input. In the exemplary embodiment, the input unit 10 may be a mouse, a keyboard or other suitable input devices.

The storage unit 20 is configured for storing a database, link information and a color code list. The database includes a plurality of image files. Content of each of the plurality of image files includes a color code. The link information is configured for linking to an image file. In the exemplary embodiment, the link information may be a hyperlink. The color code list records a plurality of numeric codes corresponding to each color code. In the exemplary embodiment, the numeric code may be a binary code etc. For example, the binary code for the red is “000000001”, the binary code for the green is “000010000”, the binary code for the blue is “100000000”, the binary code for the black is “111111111”, and the binary code for the white is “000000000”, and so on. In the exemplary embodiment, the storage unit 20 includes a nonvolatile storage module 210 and a volatile storage module 220. The nonvolatile storage module 210 is configured for storing link information, and the color code list etc. The volatile storage module 220 is configured for temporarily storing the database.

The processing unit 30 includes a read module 310, a searching condition selection module 320, a color scan module 330, a color encoding module 340, an image search module 360, and a search control module 370.

The read module 310 is configured for acquiring an image file according to the user input from the input unit 10. For example, the read module 310 acquires an image file among the plurality of image files stored in the database or acquires an image file to which the link information directs. In the exemplary embodiment, when the acquired image file is displayed on the display unit 40, the image file can be operated by the user, for example, selecting an area of the image file, or editing the image file, etc.

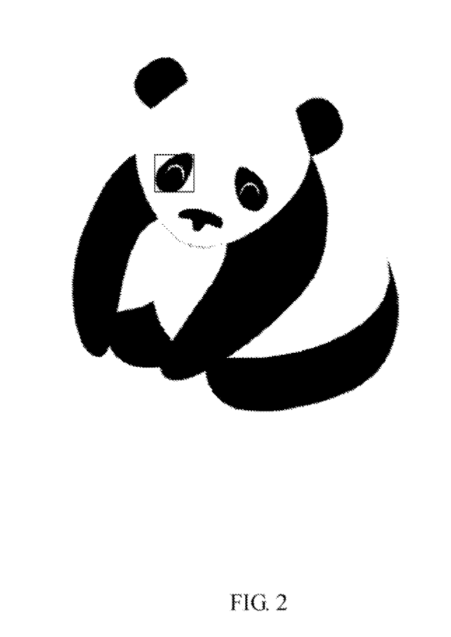

The searching condition selection module 320 is configured for receiving an area selection of the acquired image file as a search condition according to the user input from the input unit 10. As shown in FIG. 2, the image file shows a panda, the searching condition selection module 320 receives an eye area of the panda as the search condition according to the user input.

The color scan module 330 is configured for scanning and analyzing the search condition to acquire a color code corresponding to the search condition in a scan manner. In the exemplary embodiment, the scan manner may be a landscape orientation scan, a portrait orientation scan, etc. Simultaneously, the color scan module 330 is configured for scanning and analyzing the image files to acquire the color code of each of the image files. As shown in FIG. 2, the searching condition selection module 320 receives the area of the eye of the panda as the search condition; the color scan module 330 scans and analyzes the search condition to acquire a color code (i.e., white black white black white) in the landscape orientation scan manner.

The color encoding module 340 is configured for converting the color code of the selected area of the acquired image into the numeric code of the search condition according to the color code list. Simultaneously, the color encoding module 340 is configured for converting the color code of each of the image files stored in the database into the numeric codes according to the color code list. As shown in FIG. 2, the color scan module 330 scans and analyzes the search condition to acquire the color code: white black white black white. The color encoding module 340 coverts the color-code into the corresponding numeric codes: 000000000111111111000000000111111111000000000, according to the color code list.

The image searching module 360 is configured for searching the image files from the database, whose numeric code matches the numeric code of the search condition, and outputting a result.

The search control module 370 is configured for displaying the searched image on the display unit 40 according to the result.

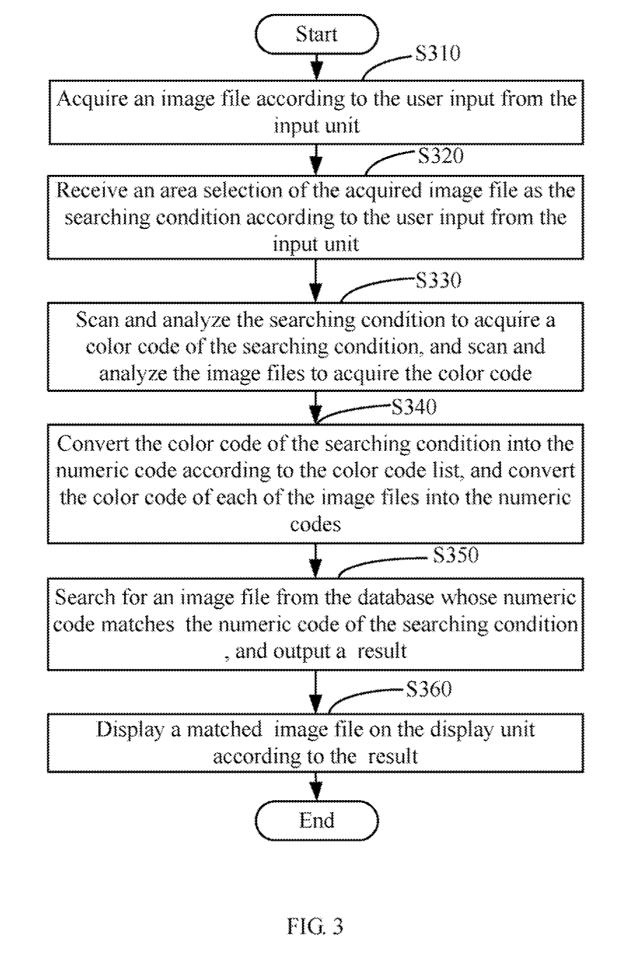

FIG. 3 is a flowchart of a searching image method implemented by the image searching system of FIG. 1 in accordance with an exemplary embodiment.

In step S310, the read module 310 acquires an image file according to the user input from the input unit 10.

In step S320, the search condition selection module 320 receives an area selection of the acquired image as the search condition according to the user input from the input unit 10.

In step S330, the color scan module 330 scans and analyzes the search condition to acquire a color code of the search condition in a scan manner. Simultaneously, the color scan module 330 scans and analyzes the image files stored in the database to acquire the color code of each of the image files in a scan manner.

In step S340, the color encoding module 340 converts the color code of the search condition into the numeric codes of the search condition according to the color code list. Simultaneously, the color encoding module 340 converts the color code of each of the image files into the numeric codes according to the color code list.

In step S350, the image searching module 350 searches for image files from the database whose numeric code matches the numeric code of the search condition, and outputs a result.

In step S360, the searching controlling module 370 displays a matched image file on the display unit 40 according to the result.

the searching controlling 370 further detects whether to continue searching, if yes, returns to the step S310; if no, ends the flowchart.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An image searching system comprising:
an input unit configured for receiving a user input;
a storage unit configured for storing a database and color code list, wherein the database includes a plurality of image files, the content of each of the plurality of image files includes a color code, the color code list records a plurality of numeric codes corresponding to each color code;
a read module configured for acquiring an image files from the database according to the user input from the input unit;
a searching condition selection module configured for receiving an area selection of the acquired image as a search condition according to the user input from the input unit;
a color scan module configured for scanning and analyzing the search condition to acquire a color code of the search condition, and scanning and analyzing the image files stored in the database to acquire a color code of each of the image files;
a color encoding module configured for converting the color code of the search condition into a numeric code of the search condition, and converting the color code of each of the image files into numeric codes according to the color code list;
an image search module configured for searching for image files from the database whose numeric code matches the numeric code of the search condition, and outputting a result;
a searching control module configured for displaying a matched image file on the display unit according to the result.

2. The image searching system as claim 1, wherein the storage unit further stores link information for linking to an image file, the read module further acquires the image file according to the link information.

3. The image searching system as claim 2, wherein the link information is a hyperlink.

4. A searching image method implemented by an image searching system which comprises an input unit for receiving an user input, a storage unit for storing a database and color code list, wherein the database includes a plurality of image files, content of each of the plurality of image files includes a color code, the color code list records a plurality of numeric codes corresponding to each color code, and a display unit, the method comprising:
acquiring an image file from the database according to the user input from the input unit;
receiving an area selection of the acquired image file as a search condition according to the user input from the input unit;
scanning and analyzing the search condition to acquire a color code of the search condition, and scanning and analyzing the image files stored in the database to acquire a color code of each of the image files;
converting the color code of the search condition into a numeric code, and converting the color code of each of the image files into numeric codes according to the color code list;
searching for image files from the database whose numeric code matches the numeric code of the search condition, and outputting a result; and
displaying the matched image file on the display unit according to the result.
